(19) United States
(12) Patent Application Publication
(10) Pub. No.: US 2009/0194709 A1
(43) Pub. Date: Aug. 6, 2009

(54) Laser processing machine with a cutting guide

(75) Inventors: Chia-Lung Kuo, Yunlin County (TW); Yan-Hua Chen, Tainan City (TW)

Correspondence Address: BACON & THOMAS, PLLC, 625 SLATERS LANE, FOURTH FLOOR, ALEXANDRIA, VA, 22314-1176, US

(73) Assignee: CONTREL TECHNOLOGY CO., LTD., TAINAN COUNTY (TW)

(21) Appl. No.: 12/155,700

(22) Filed: Jun. 9, 2008

(30) Foreign Application Priority Data
Feb. 1, 2008 (TW) 97104047

(51) Int. Cl. G21G 5/00

(52) U.S. Cl. 250/492.1

(57) ABSTRACT

A laser processing machine includes a laser device that generates a laser beam onto a workpiece when moving along a predetermined traveling path, an ultrasonic apparatus that generates a ultrasonic wave, and a guide member arranged near to and moved with the laser device along the traveling path for transferring the ultrasonic wave onto the workpiece along the traveling path. By means of the double-processing effect of the ultrasonic wave and the laser beam, the invention achieves the objects of high cutting precision, excellent product quality and fast processing speed.

### BACKGROUND OF THE INVENTION

1. Field of the Invention

The present invention relates to processing machines and more particularly, to a laser processing machine having a cutting guide.

2. Description of the Related Art

When cutting a glass substrate for LCD panel, a cutting wheel is rotated on the glass substrate to form fine cut groves on the surface of the glass substrate, and then a bending force is applied to the glass substrate to break the glass substrate along the cut grooves. According to this cutting method, the broken edge of the substrate is uneven and has cracks. Laser means may be used to substitute for the cutting wheel. By means of projecting a laser beam onto the surface of a glass substrate, the heat and energy of the laser beam are concentrated on the surface of the glass substrate, and therefore the glass substrate breaks along the traveling path of the laser beam subject to the effect of the stress.

However, either a cutting wheel or a laser beam is applied, the cut edge is not perfectly straight and, a deficit angle or cracks will be found in the cut edge.

### SUMMARY OF THE INVENTION

The present invention has been accomplished under the circumstances in view. It is the main object of the present invention to provide a laser processing machine, which achieves high cutting accuracy and obtains excellent product quality.

It is another object of the present invention to provide a laser processing machine, which achieves high-speed processing.

To achieve these and other objects of the present invention, the laser processing machine is adapted for processing a workpiece along a predetermined traveling path. The laser processing machine comprises a laser device adapted for generating a laser beam onto the workpiece and moving the laser beam along the traveling path, an ultrasonic apparatus adapted for generating a ultrasonic wave, and a guide member arranged near and movable with the laser device along the traveling path and adapted for transferring the ultrasonic wave onto the workpiece along the traveling path. By means of the double-processing effect of the ultrasonic wave and the laser beam, the laser processing machine achieves the objects of high cutting precision, excellent product quality and fast processing speed.

### BRIEF DESCRIPTION OF THE DRAWING

FIG. 1 is a schematic drawing, showing the arrangement of a laser processing machine in accordance with a first embodiment of the present invention.

FIG. 2 corresponding to FIG. 1, showing a recycling device attached to the guide member.

FIG. 3 is a schematic drawing, showing the arrangement of a laser processing machine in accordance with a second embodiment of the present invention.

FIG. 4 is a schematic drawing, showing the arrangement of a laser processing machine in accordance with a third embodiment of the present invention.

FIG. 5 is a schematic drawing, showing the arrangement of a laser processing machine in accordance with a fourth embodiment of the present invention.

FIG. 6 is a schematic drawing, showing the arrangement of a laser processing machine in accordance with a fifth embodiment of the present invention

### DETAILED DESCRIPTION OF THE INVENTION

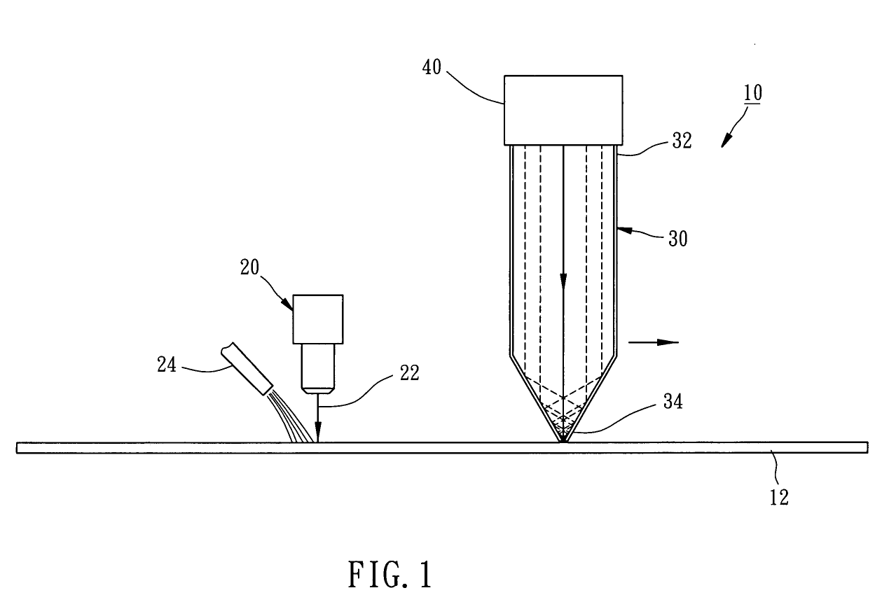

Referring to FIG. 1, a laser processing machine 10 in accordance with a first embodiment of the present invention is shown for processing a glass substrate 12 for LCD panel. The laser processing machine 10 comprises a laser device 20, a guide member 30 and an ultrasonic apparatus 40.

The laser device 20 is controlled to generate a laser beam 22 that is projecting onto the surface of the glass substrate 12 and the laser beam 22 is moving along a straight path. When the laser beam 22 is projecting onto the surface of the glass substrate 12, a cooling fluid supply device 24 ejects a jet of cooling fluid onto the glass substrate 12 at the rear side of the incident point of the laser beam 22.

The guide member 30 is a tubular member having a conical bottom side, thereby defining a relatively greater inlet 32 at the top side and a relatively smaller outlet 34 at the bottom side. The guide member 30 is filled up with water. The guide member 30 is disposed adjacent to the laser device 20 at one side in front of the path of the traveling path of the laser beam 22. The outlet 34 is kept in proximity to the top surface of the glass substrate 12.

The ultrasonic apparatus 40 is adapted for generating an ultrasonic wave and transmitting the generated ultrasonic wave into the inlet 32 of the guide member 30 so that the water in the guide member 30 works as transfer medium to transfer the ultrasonic wave out of the outlet 34 to the glass substrate 12. The guide member 30 is moved with the laser device 20 along the traveling path of the laser beam 22 when the ultrasonic wave is being transferred out of the outlet 34 to the glass substrate 12.

When operating the laser processing machine of the aforesaid first embodiment to cut the glass substrate 12, the ultrasonic wave generated by the ultrasonic apparatus 40 is transferred to the glass substrate 12, forming a line of stress zone. The internal stress in the line of stress zone is greater than the other area of the glass substrate 12. When the ultrasonic wave is moving along the traveling path and being transferred to the glass substrate 12, the laser beam 22 of the laser device 20 is being projected onto the glass substrate 12 and moved along the line of stress zone, i.e., the ultrasonic wave guides the laser beam 22, therefore the energy of the laser beam 22 is applied to the line of stress zone to increase the internal stress in the line of stress. By means of effect of the ultrasonic wave and the laser beam, the glass substrate 12 breaks straightly along the line of stress.

Because the glass substrate 12 breaks directly following the step of the ultrasonic wave and the laser beam 22, no external bending force is necessary to break the glass substrate 12. After cutting, the cut edge is smooth, neither deficit angle nor crack will be found. Further, the small working size of the ultrasonic wave and the laser beam 22 allows precise setting of the size and location of the stress zone, assuring a precise cutting work. Further, the time in which the ultrasonic wave and the laser beam works on the glass substrate 12 is short, saving much the processing time.

Therefore, by means of the double-processing effect of the ultrasonic wave and the laser beam, the invention achieves the objects of high cutting accuracy, excellent product quality and fast processing speed.

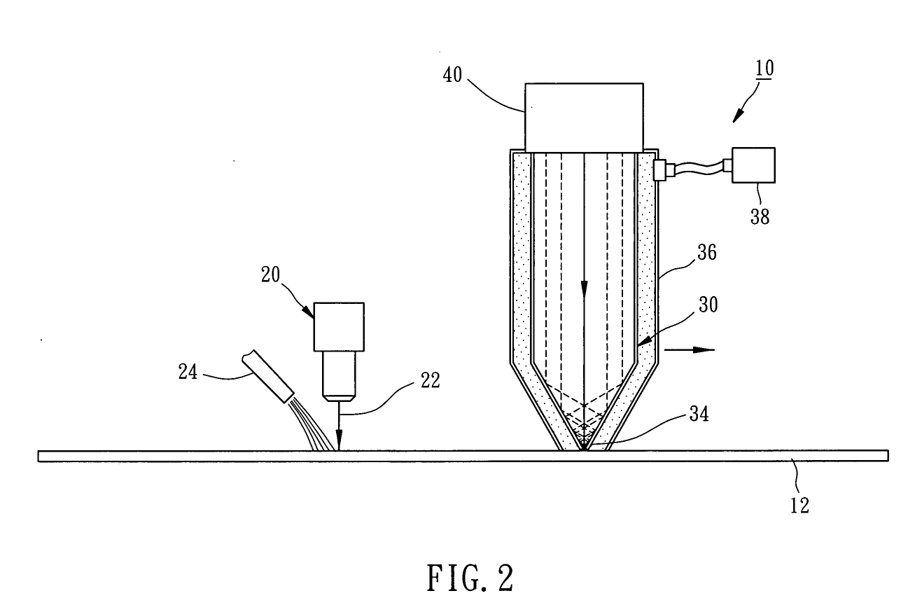

To obtain a clean processing environment, the guide member can be arranged in the form shown in FIG. 2. As illustrated, the guide member is sleeved with a nozzle tube 36, and a recycling device 38 is connected to the nozzle tube 36. The nozzle tube 36 has its conical bottom end kept in touch with the top surface of the glass substrate 12. When water is flowing out of the outlet 34 of the guide member 30, discharged water is recycled by the recycling device 38 through the nozzle tube 36, and therefore discharged water will not splash over the surface of the glass substrate 12.

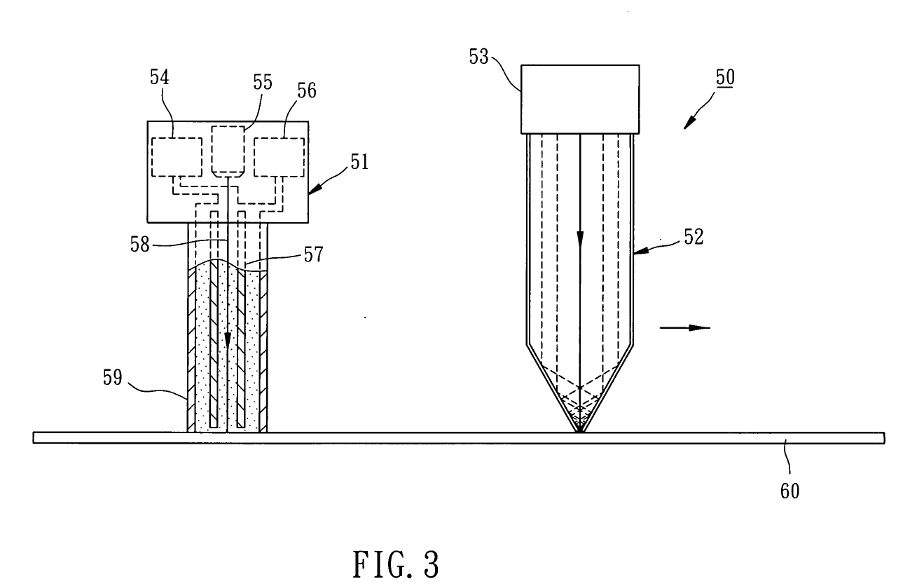

FIG. 3 illustrates a laser processing machine 50 in accordance with a second embodiment of the present invention. According to this embodiment, the laser processing machine 50 is comprised of a laser device 51, a guide member 52 and an ultrasonic apparatus 53. The guide member 52 and the ultrasonic apparatus 53 are similar to the like parts in the aforesaid first embodiment. The laser device 51 according to this second embodiment comprises a fluid supply device 54, a laser emitter 55, and a recycling device 56. The laser device 51 further comprises a first guide tube 57 downwardly extending from the bottom side in a concentric manner relative to the bottom laser output end of the laser emitter 55 and disposed in fluid communication with the fluid supply device 54. Therefore, the laser beam 58 generated by the laser emitter 55 goes through the axial center of the first guide tube 57. The laser device 51 further comprises a second guide tube 59 downwardly extending from the bottom side and surrounding the first guide tube 57 and disposed in communication with the recycling device 56. Further, the bottom open end of the second guide tube 59 is in communication with the bottom open end of the first guide tube 57 so that the fluid going through the first guide tube 57 can be drawn into the recycling device 56. When the laser device 51 is attached to the surface of the glass substrate 60, the laser beam 58 and the fluid are simultaneously applied to the glass substrate 60 to cut the glass substrate 60. During recycling of the fluid, cut chips are carried away from the glass substrate 60 by the fluid being recycled by the recycling device 56. By means of the application of this second embodiment, the invention utilizes a laser beam to cut the workpiece and an ultrasonic wave to guide the laser beam, accelerating the processing speed. Further, the recycling operation of the recycling device avoids splashing of cut chips over the surface of the workpiece, maintaining the quality of the workpiece.

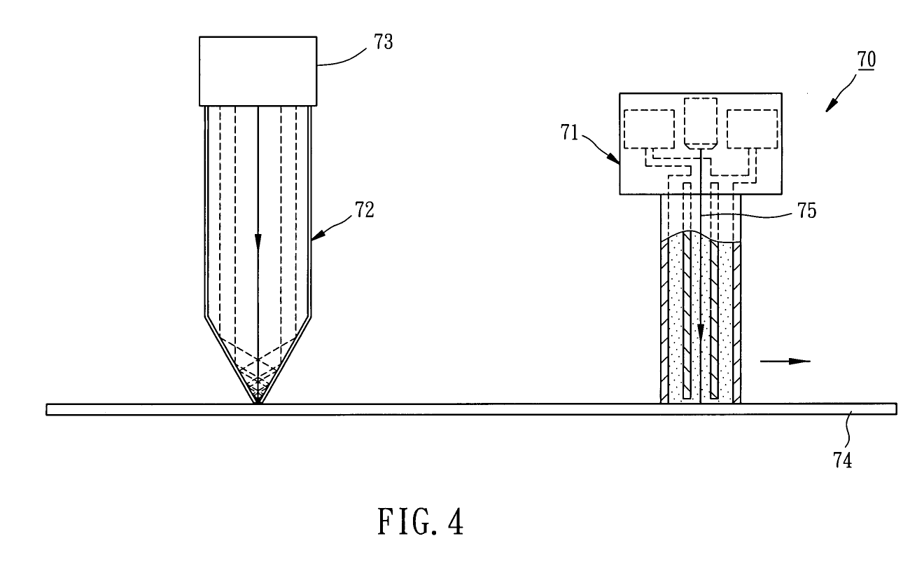

FIG. 4 illustrates a laser processing machine 50 in accordance with a third embodiment of the present invention. According to this embodiment, the laser processing machine 70 is comprised of a laser device 71, a guide member 72 and an ultrasonic apparatus 73. The laser device 71 is disposed in front of the ultrasonic apparatus 73. The laser beam 75 and fluid provided by the laser device 71 are acted upon the surface of the glass substrate 74, and then the ultrasonic wave generated by the ultrasonic apparatus is applied to cut the glass substrate 74. This embodiment can also cut the workpiece accurately, providing a smooth cut edge.

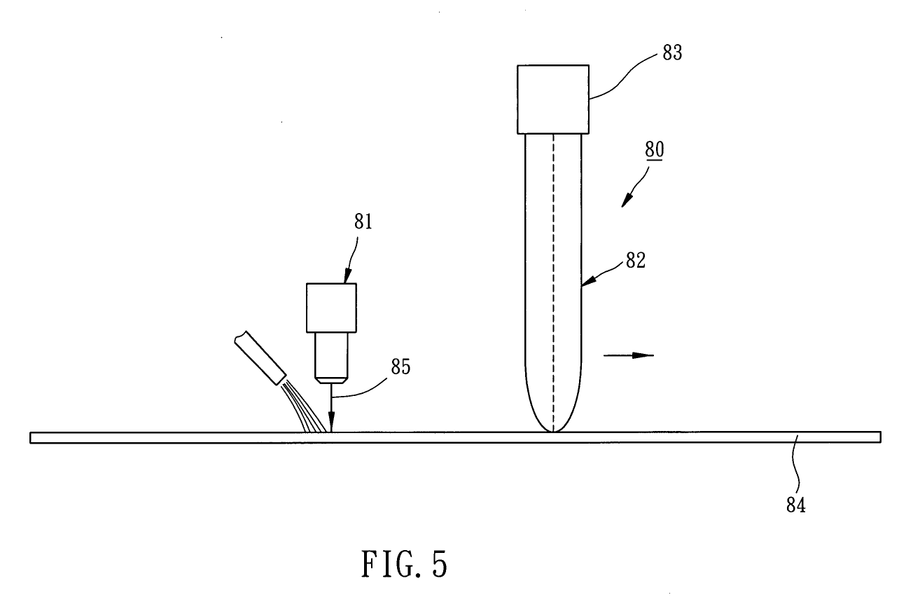

FIG. 5 illustrates a laser processing machine 80 in accordance with a fourth embodiment of the present invention. According to this embodiment, the laser processing machine 80 is comprised of a laser device 81, a guide member 82 and an ultrasonic apparatus 83. The guide member 82 is formed of a solid material that transfers the generated ultrasonic wave from the ultrasonic apparatus 83 to the surface of the glass substrate 84 directly to guide the laser beam 85 generated by the laser device 81. This fourth embodiment achieves the same effects as the aforesaid other embodiments of the present invention.

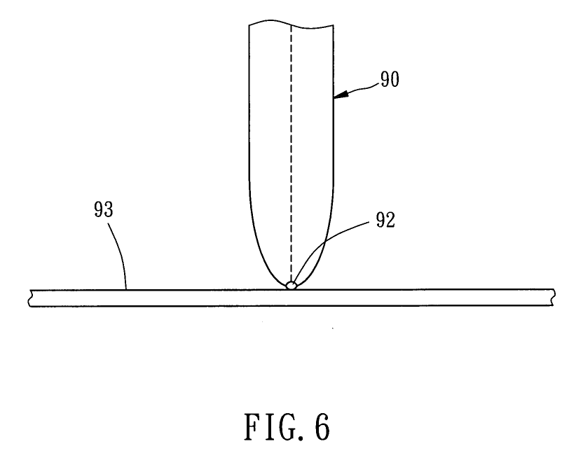

FIG. 6 illustrates a part of a laser processing machine in accordance with a fifth embodiment of the present invention. According to this embodiment, the guide member, reference 90 is a solid member having a rolling ball 92 rotatably mounted in the bottom end thereof. During application of the laser processing machine, the rolling ball 92 is kept in direct contact with the surface of the glass substrate 93 so that the guide member 90 can be moved on the surface of the glass substrate 93 smoothly without causing too much friction.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A laser processing machine for processing a workpiece along a predetermined traveling path, said laser processing machine comprising:
a laser device adapted for generating a laser beam onto said workpiece and said laser beam moved along said traveling path;
an ultrasonic apparatus adapted for generating a ultrasonic wave; and
a guide member arranged movable with said laser device along said traveling path and adapted for transferring said ultrasonic wave onto said workpiece along said traveling path.

2. The laser processing machine as claimed in claim 1, wherein said guide member having a inlet disposed in a top side thereof and a outlet disposed in a bottom side thereof in communication with said inlet and in proximity to said workpiece, said outlet having a diameter smaller than said inlet, and a fluid filled in said guide member for transferring said ultrasonic wave toward said workpiece through said outlet.

3. The laser processing machine as claimed in claim 1, wherein said ultrasonic apparatus is disposed in front of said laser device relative to the extending direction of said traveling path.

4. The laser processing machine as claimed in claim 1, wherein said laser device is disposed in front of ultrasonic apparatus relative to the extending direction of said traveling path.

5. The laser processing machine as claimed in claim 1, wherein said laser device comprises:
a fluid supply device adapted for outputting a fluid;
a first guide tube adapted for guiding the outputted fluid from said fluid supply device toward said workpiece;
a laser emitter adapted for emitting a laser beam through said first guide tube onto said workpiece;
a nozzle tube surrounding said first guide tube; and
a recycling device adapted for recycling the fluid that is outputted by said fluid supply device and guided by said first guide tube onto said workpiece

6. The laser processing machine as claimed in claim 1, wherein said guide member is formed of a solid material that transfers said ultrasonic wave from said ultrasonic apparatus to said workpiece.

7. The laser processing machine as claimed in claim 1, wherein said guide member has a rolling ball rotatably mounted in a bottom end thereof and disposed in contact with said workpiece.

8. The laser processing machine as claimed in claim 1, further comprising a cooling fluid supply device adapted for ejecting a flow of a cooling fluid onto the incident point of said laser beam at said workpiece.
